(19) United States
(12) Patent Application Publication
(10) Pub. No.: US 2008/0159733 A1
(43) Pub. Date: Jul. 3, 2008

(54) Network camera holder

(76) Inventor: Hui-Hu Liang, Siu Shui Hsiang (TW)

Correspondence Address: TROXELL LAW OFFICE PLLC, SUITE 1404, 5205 LEESBURG PIKE, FALLS CHURCH, VA, 22041, US

(21) Appl. No.: 11/647,158

(22) Filed: Dec. 29, 2006

(51) Int. Cl. G03B 17/00

(52) U.S. Cl. 396/428

(57) ABSTRACT

A network camera holder includes an L-shaped holder provided along its central line an L-shaped slot; the holder comprised of a longer arm and a shorter arm; the longer arm having a concaved surface and the longer arm having a flushed surface; a retainer and a flange being respectively disposed on the inner side of the front end of the shorter arm and the longer arm; a screw hole being disposed on the lower end of the camera; a bolt passing through the L-shaped slot and locked in the screw hole; by loosening up the bolt to allow the camera to slide within the L-shaped slot to a proper location before being tightened up; when the camera being secured to the shorter arm, the camera being hooked to an upper edge of a monitor by the retainer while the flange from the longer arm holding against the back of a monitor; and when the camera being secured to the longer arm, the camera being placed on a desktop by the flushed surface of the longer arm.

### BACKGROUND OF THE INVENTION

(a) Field of the Invention

The present invention is related to a network camera holder, and more particularly to one comprised of an L-shaped holder longitudinally provided with an L-shaped slot for a bolt to travel therein to adjust the position of the camera to either hook upon an upper edge of a monitor or be place on a desk as desired.

(b) Description of the Prior Art

Whereas a network camera generally available in the market is either placed on desktop or hooked upon a monitor, both positions are not interchangeable to limit the operation of the camera by its user. Even the prior art allows the camera to be secured in both positions as desired, the construction and erection of its holder are comparatively complicate and involve higher cost, and even more complicate in case of a construction that allows adjustable angle.

### SUMMARY OF THE INVENTION

The primary purpose of the present invention is to provide an improved construction of a network camera (PC camera) that solves the problems found with the prior art. To achieve the purpose, the present invention relates to an L-shaped holder having at its center line longitudinally disposed with an L-shaped slot; the longer arm of the holder indicates an arc surface and the shorter arm of the holder indicates a flushed surface. A retainer is disposed on the inner side at the front end of the shorter arm, and a flange is disposed on the inner side of the front end of the longer arm. A bolt passes through the L-shaped slot and locked in a screw hole disposed at where below the network camera so to secure the camera to the L-shaped slot. Accordingly, by loosening the bolt allows the camera slide in the L-shaped slot to a position as desired before tightening up the bolt again for the holder to be either placed on the desktop or hooked upon an upper edge of a monitor as desired by the user.

Accordingly, the present invention provides the following advantages:

1. When the user desires to hook the network camera to the monitor, the bolt passes through the L-shaped slot and secured to the sorter arm for its retainer to hook upon the upper edge of the monitor of a notebook while the flange from the longer arm holds against the back of the monitor to firmly secure the network camera to its hooking position.

2. When the user desires to place the network camera on a desktop, the camera is secured to the longer arm of the L-shaped holder and the flushed surface of the shorter arm is placed on the desktop to facilitate the user to adjust the angle of the camera.

3. In case of a monitor of a desktop computer and the monitor is thicker than that of a notebook, the L-shaped holder strides over the upper edge of the monitor and secured to where the transition between the longer arm and the shorter arm of the L-shaped holder takes place for the camera to be directly secured to the upper edge of the monitor in an erected status.

### BRIEF DESCRIPTION OF THE DRAWINGS

FIG. 1 is an exploded view of the present invention.

FIG. 2 is a perspective view of the present invention as assembled.

FIG. 3 is a schematic view showing a layout of a first preferred embodiment of the present invention.

FIG. 4 is a perspective view showing a second preferred embodiment of the present invention.

FIG. 5 is a perspective view showing a third preferred embodiment of the present invention.

### DETAILED DESCRIPTION OF THE PREFERRED EMBODIMENTS

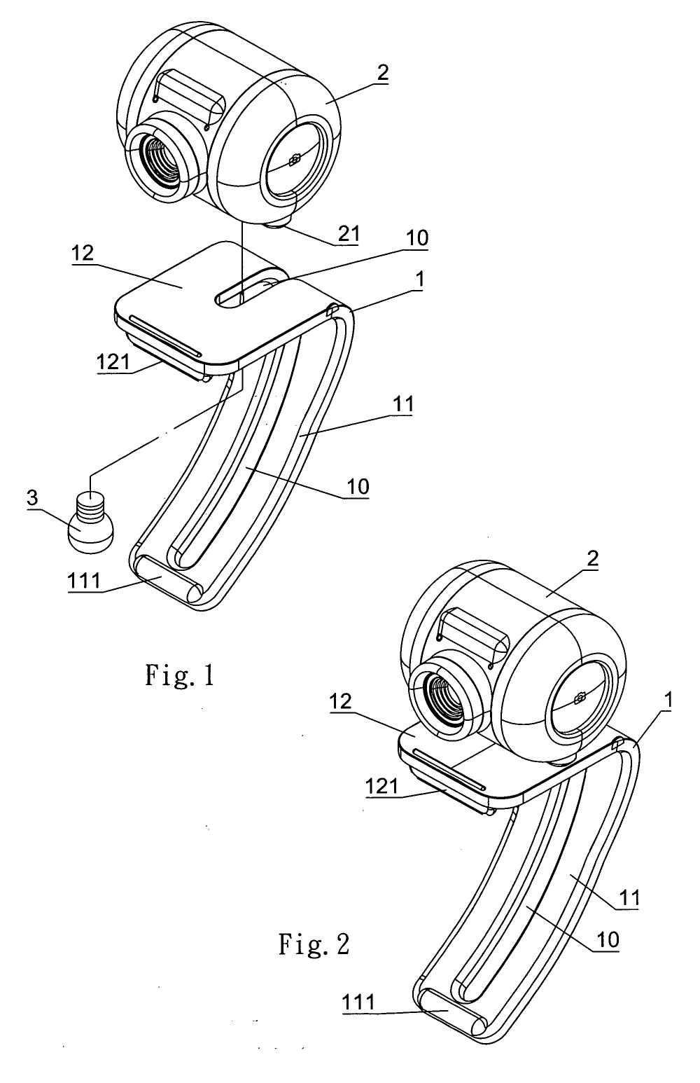

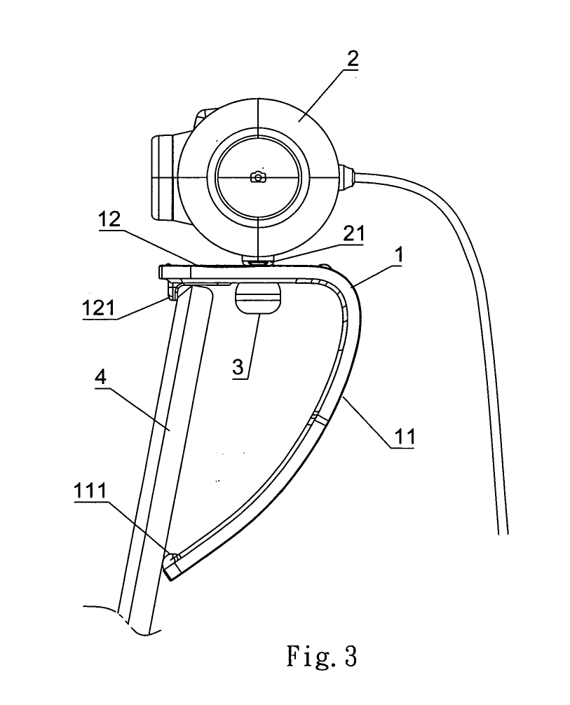

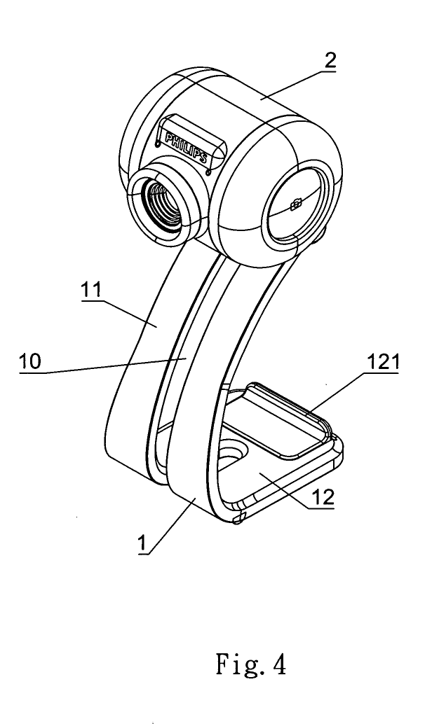

Referring to FIGS. 1, 2, and 3, an L-shaped holder 1 is longitudinally disposed at its central line an L-shaped slot 10. The L-shaped holder 1 is comprised of a longer arm 11 and a shorter arm 12. The longer arm 11 indicates a concave surface and the shorter arm 12 indicates a flushed surface. A retainer 121 is disposed on the inner side of the front end of the shorter arm 12 and a flange 111 is disposed on the inner side of the front end of the longer arm 11. A bolt 3 passes through the L-shaped slot 10 and locked in a screw hole 21 disposed at where below a network camera 2 for the camera 2 to move in the L-shaped 10 to a proper location to be secured in position by tightening up the bolt 3. Accordingly, by loosening the bolt to allow the camera 2 moving within the L-shaped slot 10, the camera 2 can be secured in a position as desired depending whether the L-shaped holder 1 to be placed on desktop as illustrated in FIG. 4 or hooked upon the upper edge of a monitor 4 as illustrated in FIG. 3 for the present invention to achieve its dual purposes by means of a summary construction.

Referring to FIG. 3, the camera 2 is fixed to the shorter arm 12 of the L-shaped holder 1 by means of the bolt 3 fastened in the L-shaped slot 10; and the camera 2 is hooked upon the upper edge of the monitor 4 by the retainer 121 while the flange 111 from the longer arm 11 of the L-shaped holder holds against the back of the monitor 4 to firmly secure the camera 2.

As illustrated in FIG. 4, the camera 2 slides to a proper location on the longer arm 11 of the L-shaped holder 1 and the shorter arm 12 has its flushed surface lying on the desktop so that the user may adjust the angle of the camera 2 to the height desired.

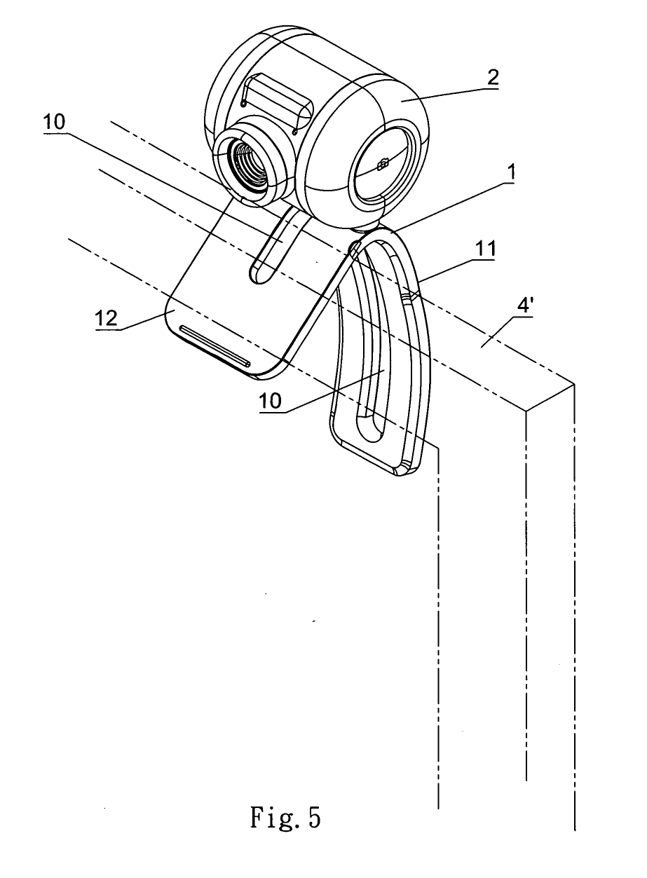

When the monitor 4′ relates to a desktop model as illustrated in FIG. 5 and is thicker than that of the monitor of a notebook 4, the bolt 3 passes through the L-shaped slot 10 to be locked in the screw hole 21 and secured to the L-shaped slot 10 at where the transition between both of the longer arm 11 and the shorter arm 12 of the L-shaped holder. Accordingly, the L-shaped holder 1 is directly striding over the upper edge of the desktop monitor 4′ at where the transition takes place for the camera 2 to be erected at a straight up status.

What is claimed is:

1. An improved construction of a network camera holder comprised of an L-shaped holder, an L-shaped slot longitudinally disposed on the central line of the L-shaped holder, the L-shaped holder comprised of a longer arm and a shorter arm each respectively provided at the inner side of the front end with a retainer and a flange; a camera provided at its lower end a screw hole; a bolt passing through the L-shaped slot and locked in the screw hole; the camera sliding in the L-shaped slot and secured at where desired by means of the bolt; and the displacement of the camera within the L-shaped slot becoming adjustable by loosening up the bolt for the camera to be either placed on a desktop or hooked upon an upper edge of a monitor.

2. The network camera holder as claimed in claim 1, wherein one arm of the L-shaped holder related to a flushed surface and another a concave surface; the holder is placed on a desktop with the end having the flushed surface; and the concave surface supports the camera against the back of a monitor when the camera is hooked upon the monitor.

3. The network camera holder as claimed in claim 2, wherein the L-shaped holder is comprised of a longer arm and a shorter arm; and the shorter arm is hooked upon an upper edge of a monitor or erected on a desktop.

4. The network camera holder as claimed in claim 1, wherein the camera strides over an upper edge of a desktop monitor in an erected position; wherein, the bolt passing through the L-shaped slot and locked in the screw hole to be secured to the L-shaped slot at where the transition between the longer arm and the sorter arm takes place.
